(19) United States
(12) Patent Application Publication
(10) Pub. No.: US 2013/0080201 A1
(43) Pub. Date: Mar. 28, 2013

(54) SYSTEM AND METHOD FOR TRACKING TASK DATA

(71) Applicant: Dustin Miller, Napa, CA (US)

(72) Inventor: Dustin Miller, Napa, CA (US)

(21) Appl. No.: 13/624,926

(22) Filed: Sep. 22, 2012

Related U.S. Application Data
(60) Provisional application No. 61/538,164, filed on Sep. 23, 2011.

(51) Int. Cl. G06Q 10/00

(52) U.S. Cl. 705/7.15

(57) ABSTRACT

The present invention is directed to system and process for inputting, tracking, monitoring, and displaying the progress and status of the tasks within a project. The system is comprised of an application server, having a team directory and a project database, in communication with a member client and a manager client over a network. A manager client is configured with a plurality of interfaces to input users, create an adaptive, group based permission structure, select team members, and input tasks. The permissions structure allows a team member to be assigned to multiple groups with differing permission for different project functions. The system determines an effective permission based on the multiple group membership. The member client is configured with a plurality of interfaces to create and update task information. The manager client is further configured with a plurality of interfaces to monitor and input project information in response to project events and information. Specifically, the system allows a client to input a dependency hold status, which is visible to the project manager, the person creating the dependency, and other team members, reducing interference with task performance for redundant communication.

The present invention claims priority to provisional application 61/538,164, which has a filing date of Sep. 23, 2011, which is hereby incorporated by reference.

### BACKGROUND

1. Field of the Invention

The present invention relates to task management, more specifically to a system and process for inputting, monitoring, and tracking task status.

2. Description of the Related Art

The modern work environment has changed and project tracking systems have not kept up to date with the work environment. People are expected to accomplish more and time is at a premium. People may be members of multiple teams. Today, project teams and resources may include traditional employees, contractors, and vendors. Moreover, the project team members and project resources may be geographically dispersed across a building, city, region, or country. Some team members may be working in a traditional office environment, while others may be working from semi-private locations using publicly available communication networks. Moreover, there may be frequent additions and departures from the project team. Unique security risks are presented by frequent change of project team members and the transmission of project data over public networks. Keeping abreast of the project status of the modern project team, while securing the project information, can present unique challenges for the project manager.

Projects are often managed by dividing the project into major tasks that must be completed in order to complete the project as a whole. Those major tasks are then subdivided into sub-tasks. The lower level tasks are eventually assigned to team members. When the project is executed, the tasks are tracked in order to monitor the project status. Software systems are often used to input, track, and manage the progress and status of the project. Older systems typically use graphs, charts, timelines, and checklists to do so. Those systems are successful in displaying the project status but fail to adequately collect task status and make it available to team members and project managers. The project manager does not know the status of individual tasks, thus he or she must contact team members to determine the status of tasks. Then the project manager inputs that status into the system. That approach also limits the visibility of other team members for related or dependent tasks. Furthermore, that approach is cumbersome, in that it is not integrated into the project process, thus consuming unnecessary, additional time. It also requires communication outside those project status systems via such means as telephone or email, creating a loss of project history.

For the above reasons, it would be advantageous to have a project status system which is seamlessly integrated into the project process, is secure, and addresses the needs of the modern project team.

### SUMMARY

The present invention is directed to system and process for inputting, tracking, monitoring, and displaying the progress and status of the tasks within a project. The system is comprised of an application server, having a team directory and a project database, in communication with a member client and a manager client over a network. The system optionally employs a flexible security model to the project data. A manager client is configured with a plurality of interfaces to input users, create an adaptive, group based permission structure, select team members, and input tasks. The member client is configured with a plurality of interfaces to create and update task information. The manager client is further configured with a plurality of interfaces to monitor and input project information in response to project events and information.

These and other features, aspects, and advantages of the invention will become better understood with reference to the following description, and accompanying drawings.

### BRIEF DESCRIPTION OF THE DRAWINGS

FIG. 1 depicts a block diagram of an embodiment of the system;

FIG. 2 depicts an overview of the process implemented to the system of FIG. 1;

FIG. 3 depicts an encryption process of an embodiment of the system;

FIG. 4 sample input data for the encryption and decryption process of FIGS. 3 and 6;

FIG. 5 depicts sample output from the process of FIG. 3;

FIG. 6 depicts a decryption process of an embodiment of the system of FIG. 1;

FIG. 7 depicts server side encryption and decryption configurations of the system of FIG. 1;

FIG. 8 depicts an embodiment of a representative interface in an initial state for inputting new users;

FIG. 9 depicts an embodiment of a representative interface in an initial state for configuring the project environment;

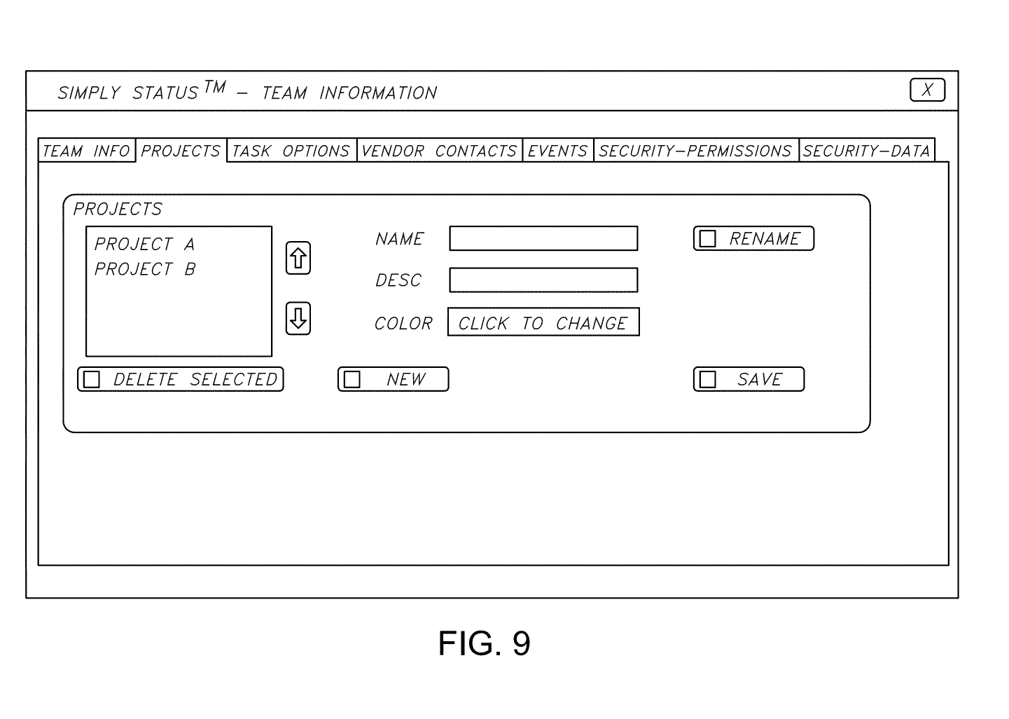

FIG. 10 depicts effective permissions for a representative input permission set;

FIG. 11 depicts a representative interface for configuring group permissions;

FIG. 12 depicts a representative interface for configuring team member group assignments;

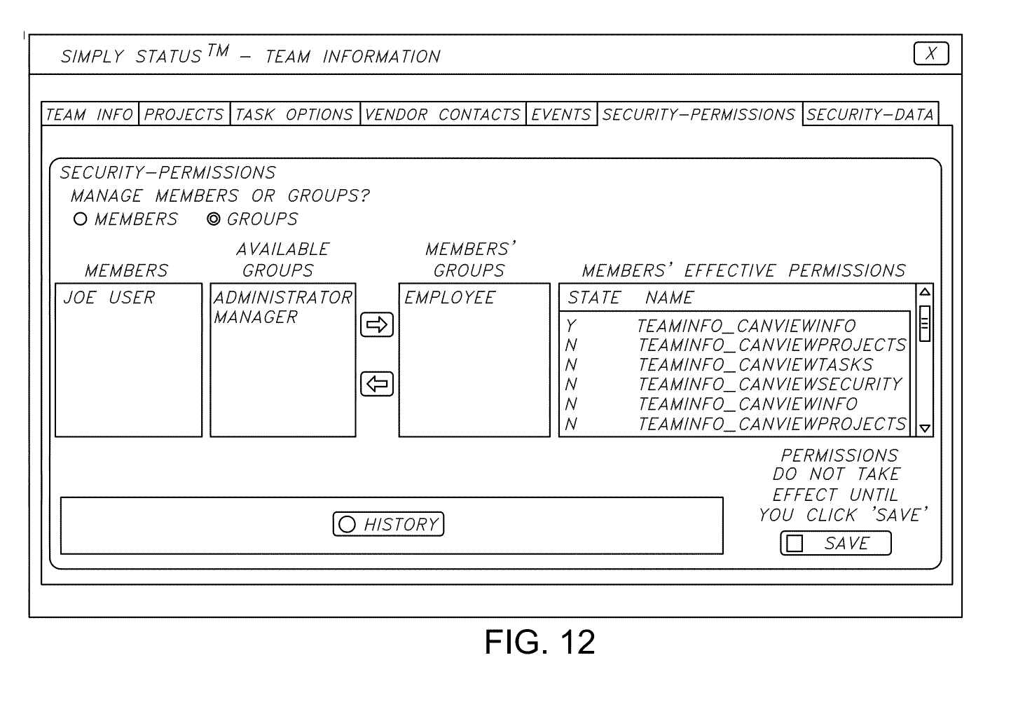

FIG. 13 depicts a representative interface for creating and editing tasks;

FIG. 14a depicts a representative interface for creating project alerts;

FIG. 15 depicts a representative interface for creating project alerts with a helper application;

FIG. 16 depicts a representative interface for indicating a task is on dependency hold;

FIG. 17 depicts a representative interface for indicating team member workload;

FIG. 18 depicts a representative interface for monitoring and inputting project alerts; and

FIG. 19 depicts a representative project manager interface.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

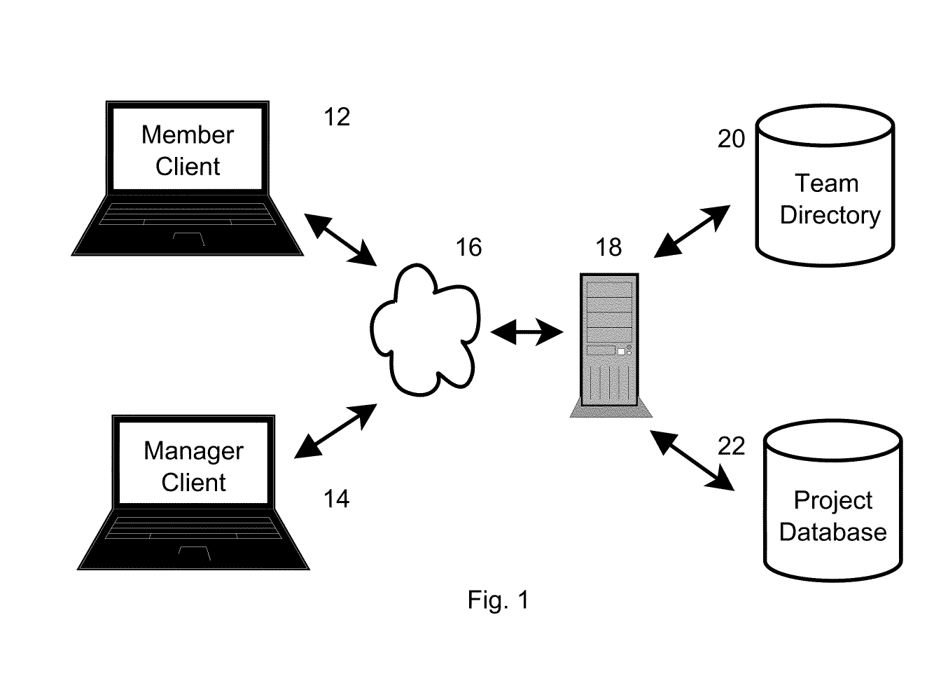

The present invention is directed to a system and process for inputting, tracking, managing, and displaying the progress and status of the tasks within a project. FIG. 1 illustrates a block diagram of an embodiment of the system in operation. It discloses a manager client 14, a member client 12, a network 16, an application server 18, a team directory 20, and a project database 22. The manager client 14, the member client 12, and the application server 18 are implemented on computers. A computer or server as referred to in this specification generally refers to a system which includes a central processing unit (CPU), memory, a screen, a network interface, and input/output (I/O) components connected by way of a data bus. The I/O components may include for example, a mouse, keyboard, buttons, or a touchscreen. The application server 18 includes various server software programs to interact with other computers over the network 16. Specifically, the application server 18 includes application serving software and a database management system. The preferred application server software is Microsoft Internet Information Services (IIS) and the preferred database management system is MySQL. The network 16 includes a variety of network components and protocols known in the art which enable computers to communicate. The computer network may be a local area network or wide area network such as the internet. The network may include modem lines, high speed dedicated lines, packet switches, or similar components. The network protocols used may include those known in the art such as UDP, TCP, IP, IPX, or the like. Additional communication protocols may be used to facilitate communication over the network 16, such as the published HTTP protocol used on the world wide web or other application protocols. The clients 12 14 and application server 18 can employ transport level encryption when communicating, preferably using the Secure Sockets Layer (SSL) or Transport Layer Security (TLS) protocols.

The manager client 14 is a computer implemented with instructions and interfaces generally to support the functions of a project manager, such as creating tasks, assigning tasks, and monitoring task status. The member client 12 is a computer implemented with instructions and interfaces generally to support the functions of a team member performing tasks on a project, such as updating tasks status and information. The clients 12 14 preferably communicate with the application server 18 via remote function calls to the application server in the form of web service calls. All data retrieved from the application server 18 is typically held in client memory only, though it may be held in server memory or in both server memory and client memory. Preferably the team directory 20 and project database 22 completely reside on the application server. In other words, no project data, except for log data, is written to the local disk of the clients 12 14.

The team directory 20 is a repository of information of the team members and related information for a project. The project database 22 is a repository of information of the tasks and related data for a project. Although shown as two separate repositories, it is to be understood that the information may be contained within one or more tables.

Sensitive data within the team directory 20 or project database 22 is optionally encrypted within the directory and database, thwarting physical access to the information. In a first configuration, the member client 12 or manager client 14 employs means known in the art to encrypt data. One such approach is to call an encryption function within the database management system of the application server 18 in order to encrypt the sensitive data.

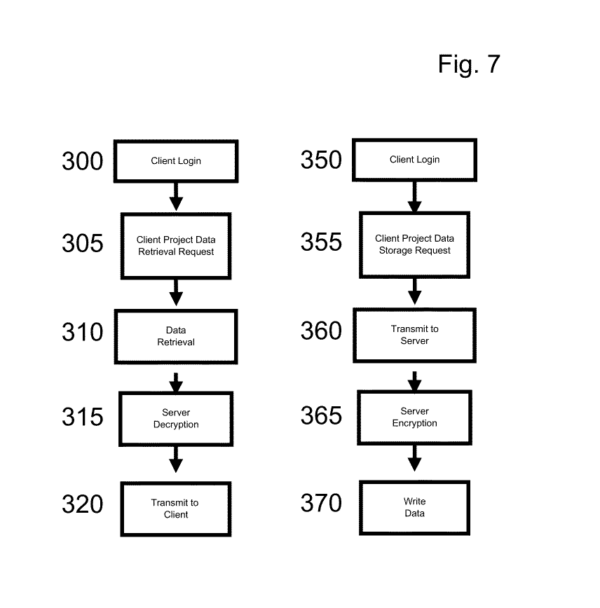

FIG. 7 illustrates a second configuration where the application server 18 completely manages the encryption and decryption. The application server 18 uses a server level encryption key for the encryption and decryption. In order to access project data, the client 12 14 authenticates to the application server 18 300. The client 12 14 requests project data 305. The application server 18 retrieves the encrypted project data from the team directory 20 or project database 22 310. At step 315, the application server decrypts the retrieved data using the project encryption key. The application server 18 transmits the plain text data to the client 12 14. It is to be understood that the data may be encrypted during transport using protocols such as SSL, TLS, or other means in the art, as previously disclosed.

In order to store project data after manipulation by the client 12 14 in this second configuration, the client 12 14 authenticates to the application server 18 350. Next, the client 12 14 sends a request to the application server 18 to store project data 355. At step 360, the client 12 14 transmits the plain text data to the application server 18 360. The application server 18 encrypts the project data using the project encryption key 365 and writes the encrypted data to the database 370.

The preferred approach is encryption at the client 12 14 prior to transmission and storage in the database and decryption at the client 12 14 subsequent to retrieval from the database, enabling project information to be controlled at the client 12 14 level. The manager client 14 is used to create an encryption key and password combination when the project is created and configured. This embodiment uses a standard XML type data wrapper for the information to be encrypted, although other data formats may contain the structure of this embodiment. A representative data block of the current configuration use the following structure:

<projectfield>

<Data>byte[ ]</Data>
<Hash>byte[ ]</Hash>
<DataFormat>byte[ ]</DataFormat>
<DataEx>byte[ ]</DataEx>
<DataEx2>byte[ ]</DataEx2>
<DataEx3>byte[ ]</DataEx3>

</projectfield>

The contents of the “Data” element contain the project information, in its encrypted or unencrypted format. The contents of the “Hash” element contain a hash of the data in unencrypted form. The hash employed can be those known in the art, such as SHA-256. The “DataFormat” element contains the type of encryption applied to the Data element. Each of the “DataEx”, “DataEx2”, and “DataEx3” contain parameters corresponding to the type of encryption applied, where those additional parameters are necessary. Each of the DataFormat, DataEx, DataEx2, DataEx3, and Hash elements can optionally contain an array of values.

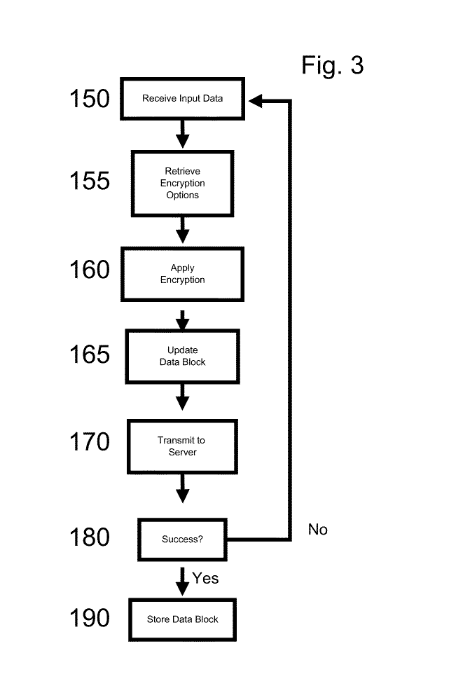

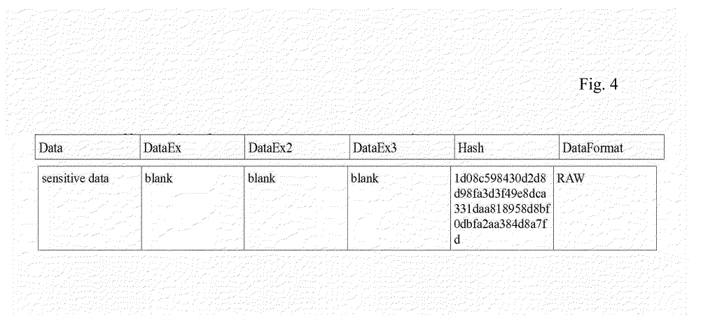

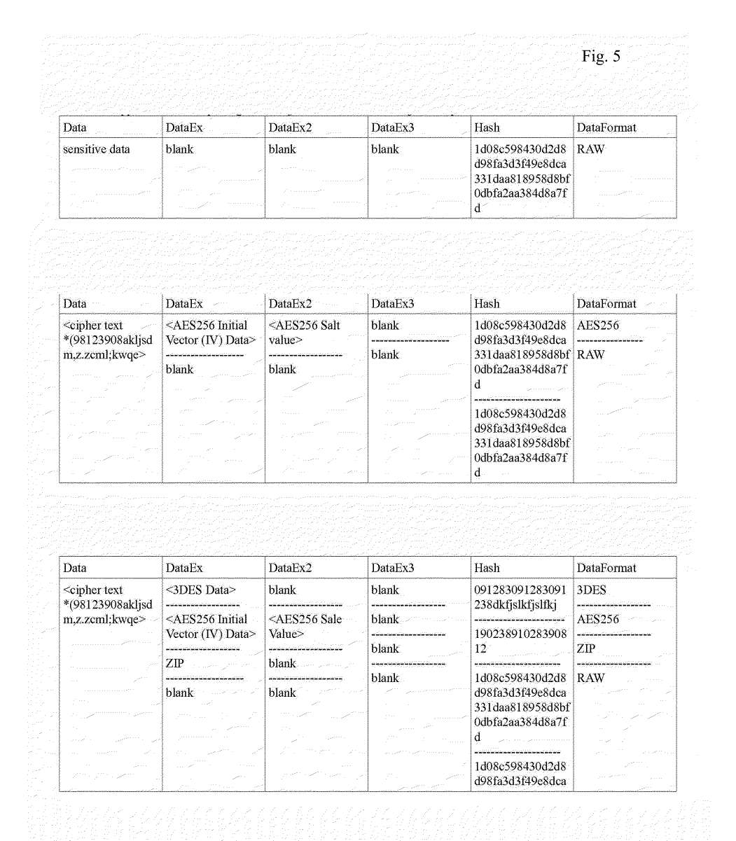

FIG. 3 shows a representative process for encryption using the representative data block of FIG. 4 for input. At step 150, the sensitive data is input into the client 12 14 and a hash of the Data element is calculated, preferably using the SHA-256 standard. The client 12 14 retrieves the encryption options 155. The clients 12 14 include encryption standards such as Advanced Encryption Standard (AES), Triple DES, ZIP, and other encryption standards in the art. The client 12 14 applies the selected encryption standard to the Data element 160. Next, the client 12 14 updates the Data element with the encrypted Data, the Hash element with the hash, the DataFormat with the selected encryption standard or standards, and the DataEx elements with any necessary parameters 165. The updated data block is transmitted to the application server 170. The data block is then stored 190. FIG. 5 represents possible data blocks output after the application of encryption. The first data block shows a block where no encryption was chosen. The second and third data blocks show multiple, successive encryption standards applied to the data block.

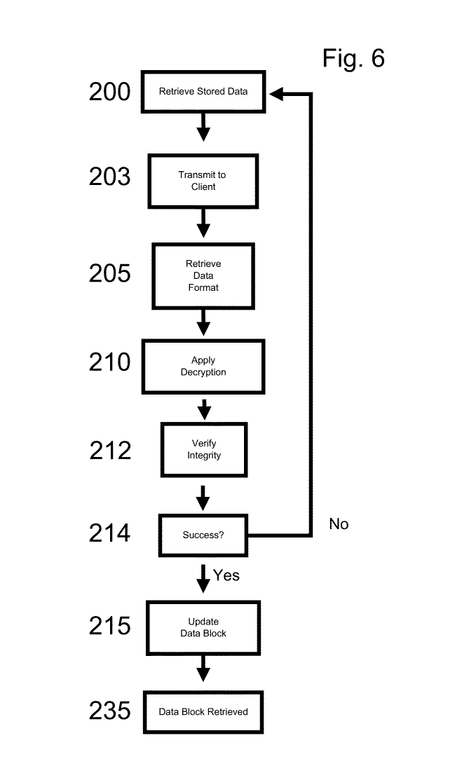

FIG. 6 shows a representative process for decryption using the representative data block of FIG. 5 as input. At step 200, the application server 18 retrieves the data block containing the encrypted data. The application server 18 transmits the encrypted data block to the client 12 14 203. The client 12 14 decrypts the Data element using the decryption standard listed in the DataFormat element and the parameters from the DataEx, DataEx2, and DataEx3 elements where necessary. In the present example, the input data block contains multiple data layers as is indicated by the multiple values in the DataFormat element. The client 12 14 first decrypts the AES-256 layer using the Initial Vector and Salt parameters, leaving the second layer of the data block. However, in this case, the DataFormat value of the remaining layer is “RAW”, thus no further decryption is necessary. After decrypting each layer, the hash of the decrypted data is calculated and compared with the hash stored in the HASH element 212. If these two hashes are equivalent 214, then each layer of the decryption was successful. Next, the client 12 14 updates the data block 215. The data block retrieval is complete 235. FIG. 4 represents the data block output after the application of decryption.

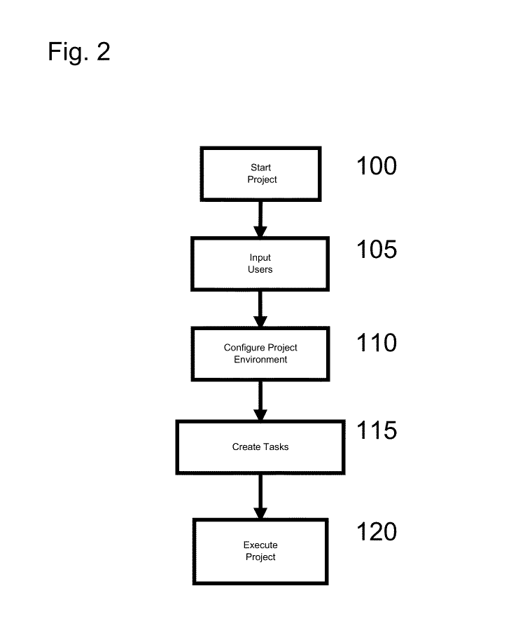

Having laid the foundation for the infrastructure of the system, FIG. 2 illustrates an overview of the major phases in using the system. After starting the project 100, the first major phase is to input system user data 105. Next, the project environment and team members are created 110. The project tasks are created and optionally assigned 115. Finally, the project moves into the execution phase 120.

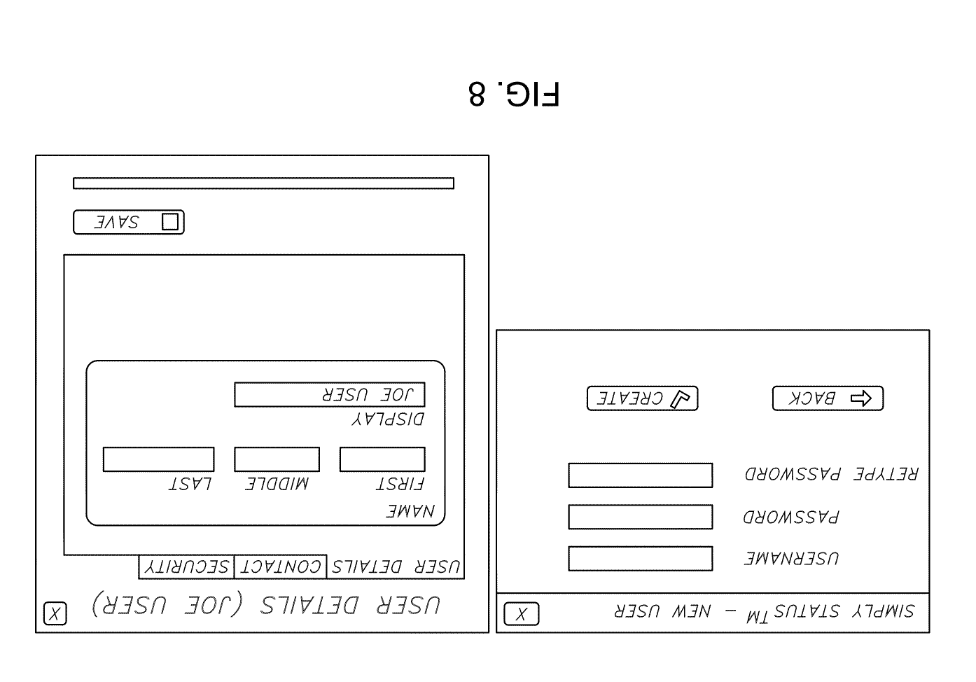

The first step is to input system users 105. FIG. 8 illustrates a representative interface in its default state. A client 12 14 is used to create or edit a user profile. As used in this specification, a user can include employees, vendors, contractors, or other individuals or entities who can perform tasks within a project. The user inputs personal information about the user such as name, address, email address, telephone numbers, skill set, and the like. The user can also choose a username and password combination. The system stores the user profile.

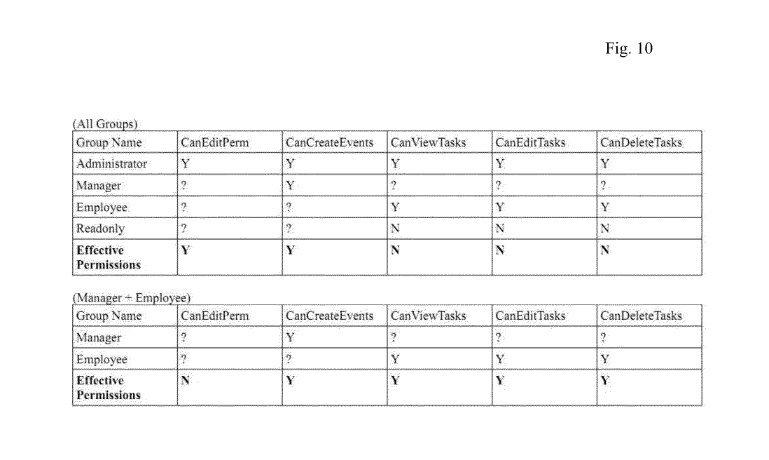

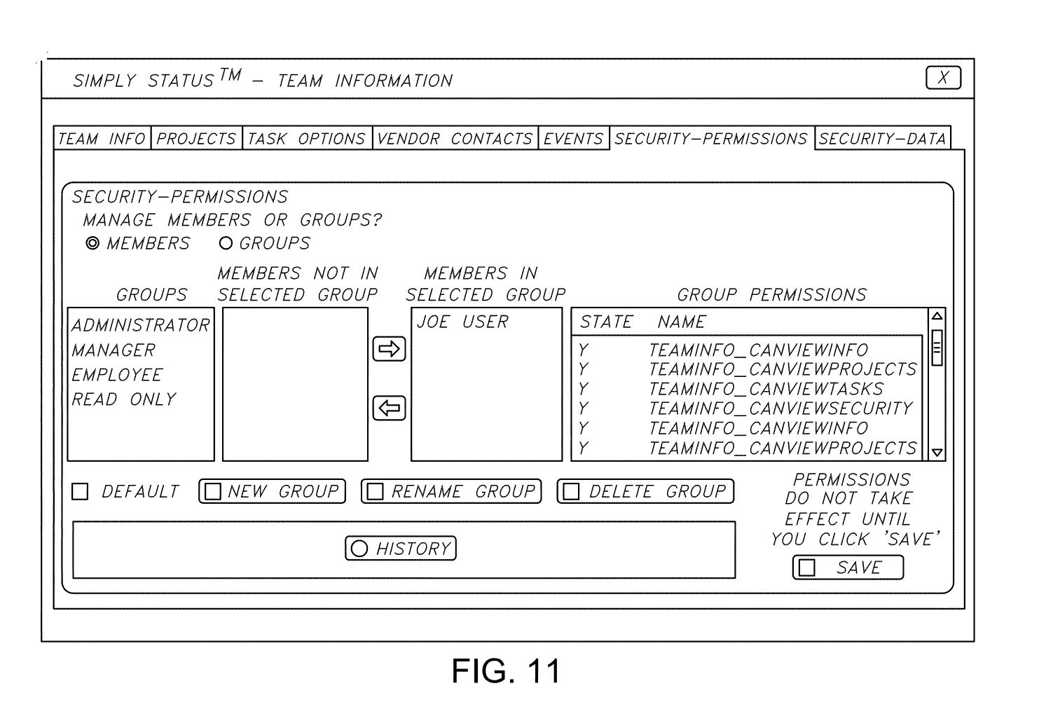

The next step is to create the project environment 110. The system creates a team directory 20 and a project database 22. In configuring the project environment, it is necessary to configure the security and permission aspects available to the team members. The current invention employs a flexible, adaptive security and permissions approach. FIG. 10 shows a representative logic table used for permissions within a project. The system predefines a set of project functions performed during the phases of a project for which access can be controlled and the system user may define further project functions. The shown project functions include the ability to edit permissions within a project (shown as CanEditPerm), create events within a project (shown as CanCreateEvents), view tasks within a project (shown as CanViewTasks), edit tasks within a project (shown as CanEditTasks), and delete tasks within a project (shown as CanDeleteTasks). As shown in FIG. 11, configurable permissions for other project functions are included in the system. The system permits a project manager to use the manager client 14 to define a set of groups into which a team member can be assigned. A team member can be assigned to more than one group depending on the role of that team member. The shown groups include Administrator, Manager, Employee, and Read Only groups. For a given group and project function, the manager client 14 is used to set an indicator for that permission. The system permits the manager to input either a permission value, preferably a boolean indicator (denoted in the table as “Y” for Yes and “N” for No) or leaving the permission undefined (denoted in the table as “?”).

After the manager, defines the groups and configures the permissions for the project, the team members are added. The manager client 14 is used to add the team members to the team directory 20. The manager client is used to select users for addition to the team directory 20. The system may assign additional user credentials such as project specific logon information or project specific encryption keys to the team member's entry.

After a team member is added, the team member is assigned to one or more groups. The system determines an effective permission for the assigned team member for each of the project functions. As mentioned, any group can contain a Yes, No, or undefined indicator for each project function. In order to determine the effective permission, the system retrieves the group membership for the team member from the team directory 20.

Where the team member is a member of only one group, the possible input indicators are Yes, No, or Undefined. The effective permission for a Yes or No input is the same as the input, namely, Yes and No respectively. The effective permission for an Undefined input depends on configuration of the system. The system can be configured in a restrictive or permissive state. In a restrictive state, where the input for the group membership is Undefined, the system will use No as the effective permission and not permit the team member to perform the project function. In a permissive state, where the input for the group membership is Undefined, the system will use Yes as the effective permission and permit the team member to perform the project function.

Where the team member is a member of more than one group, the system also employs configurable logic to determine the effective permission. Again, the system can be configured in more restrictive or permissive states, depending upon the project needs. Below is a possible logic table of the effective permissions under given permissions for two possible states assuming that a team member is assigned to both Group 1 and Group 2. Under this logic table where the memberships explicitly include one permission type and the remaining are undefined, the explicit permission controls. That is, if the memberships are “Y”, “?”, “?”, then effective permission will be “Y”. And likewise for “N”. It should be appreciated that this table is but one possible configuration.

| | | | | |
|---|---|---|---|---|
| CanEditTask | CanEditTask | CanEditTask | CanEditTask | CanEditTask |

Permissive

| | | | | | | | | | |
|---|---|---|---|---|---|---|---|---|---|
| Group 1 | Y | Group 1 | Y | Group 1 | Y | Group 1 | N | Group 1 | ? |
| Group 2 | Y | Group 2 | N | Group 2 | ? | Group 2 | ? | Group 2 | ? |
| Effective | Y | | N | | Y | | N | | Y |
| Permission | | | | | | | | | |

Restrictive

| | | | | | | | | | |
|---|---|---|---|---|---|---|---|---|---|
| Group 1 | Y | Group 1 | Y | Group 1 | Y | Group 1 | N | Group 1 | ? |
| Group 2 | Y | Group 2 | N | Group 2 | ? | Group 2 | ? | Group 2 | ? |
| Effective | Y | | N | | Y | | N | | N |
| Permission | | | | | | | | | |

The above logic can be extended to a situation where a team member is assigned to more than two groups. FIG. 10 illustrates a scenario where a team member is assigned to four groups and the system is configured in a restrictive state. The team member is assigned to the Administrator, Manager, Employee, and ReadOnly groups. For the Edit Permissions project function, the Administrator group (CanEditPerm) has permission to Edit Permission. The remaining groups leave the Edit Permission project function undefined. Thus, the system compares the Y of the Administrator group assignment with the remaining three undefined indicators. Because the system is configured in the restrictive state, the effective permission for this project for this team member for this project function is Yes, meaning this team member can Edit Permissions. Contrast this with the ability to View Tasks (CanViewTasks), Edit Tasks (CanEditTasks), or Delete Tasks (CanDeleteTasks). The team member is assigned to groups which explicitly permit the three project functions (Administrator and Employee), groups which explicitly do not permit the three project functions (ReadOnly), and a group which is undefined for the three project functions (Manager). The system logic uses an effective permission value for this project for this team member for this project function of No, meaning this team member cannot View Tasks, Edit Tasks, or Delete Tasks.

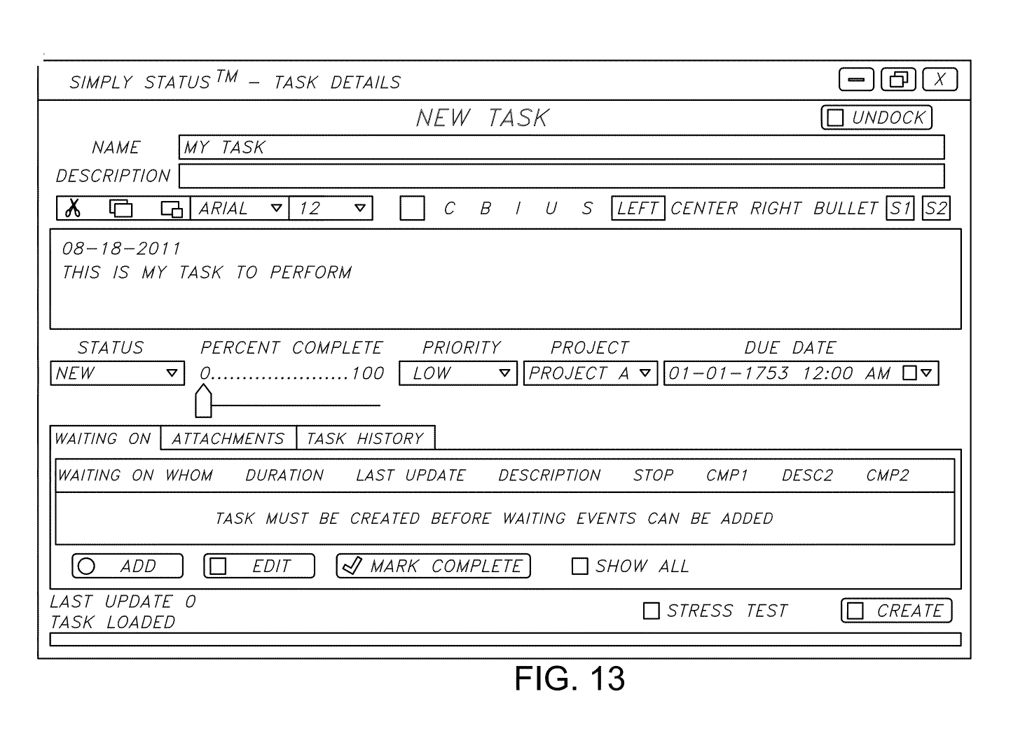

Referring back to FIG. 2, having input the users 105 and configured the project environment 110, the next step is to create tasks 115. FIG. 13 depicts an interface of the manager client 14 or member client 12 used to input task information. Task information includes a task name, task description, due date, priority, percent complete, and status. The tasks are optionally assigned to team members in this stage. The new task information is stored in the project database 22.

In addition to creating task information, the system can store project alerts. Project alerts are used to monitor, notify, and track resources within the project. For example, the status or availability of a development server may be relevant to the project. The system permits manual or automated updates to the condition being monitored for the resource. The interface holds input for the event being monitored. Upon a change in the monitored condition, the project alert entry stores the input for the new status and optionally notifies team members.

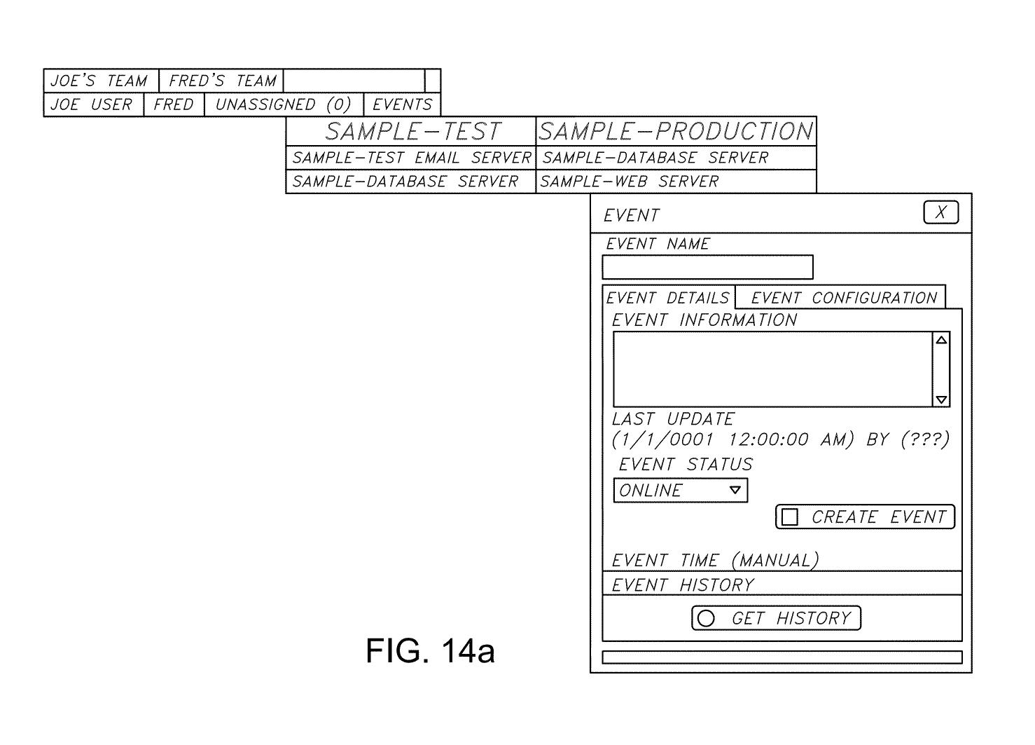

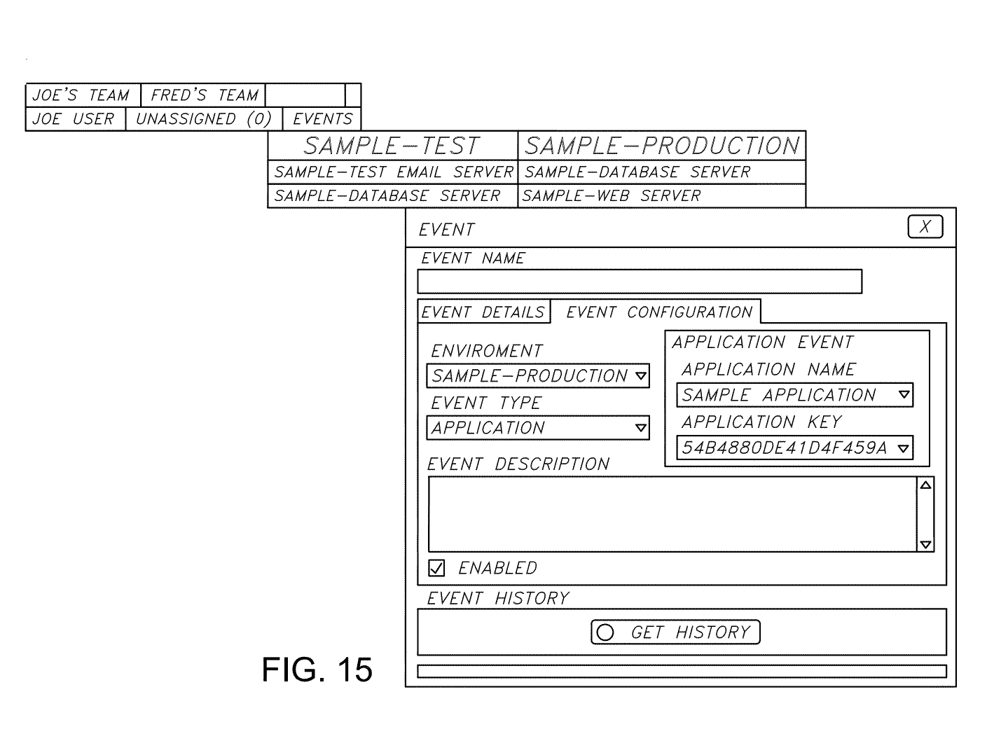

The clients 12 14 are used to create the project alert. FIG. 14a shows an interface for inputting project alerts. A name and description are input for the project alert and the system assigns a unique identifier. As mentioned, the status can be manually monitored or use automated input. Where automated input is used, the system employs associated helper applications to monitor the status of the resource and generate the alert. FIG. 15 illustrates an interface for configuring a helper application. The user inputs identifying information for the helper application. After the helper application is initiated, it can communicate with the application server 18 over the network 16 using the project alert's unique identifier as the key.

Referring back to FIG. 2, after the tasks and the projects alerts are created 115, the project moves into the execution phase 120, where the team members perform the previously defined tasks.

Team members and project managers log onto the system using a user name and password or other credentials. Upon logon, the application server 18 provides the client 12 14 a session identifier that is used for the remainder of the session. This session identifier validates that the user has logged onto the system before attempting to perform the requested function. The client 12 14 is also provided a refresh ID that allows the application server 18 to notify clients 12 14 of updates to project information. Clients 12 14 can call a check-in function over the network that allows them to get project data updates from the application server 18. When the check-in function is called, the application server 18 returns all data that has changed for this client 12 14 since the last time the check-in function was called. The frequency of the call to the check-in function is based first on the timeout period that is provided when the user logs onto the system.

As team member progress through tasks, they can update the status for each of those tasks. For example, when the team member starts a task, is in progress on a task, or completes a task, he or she may update the task information, subject to the permissions. FIG. 13 shows an interface configured to the member client 12 or the manager client 14 to update a task. The interface presents inputs for updating percent complete, status, due date, priority, status, and the assigned team member. Additionally the interface presents input for notes or file attachments.

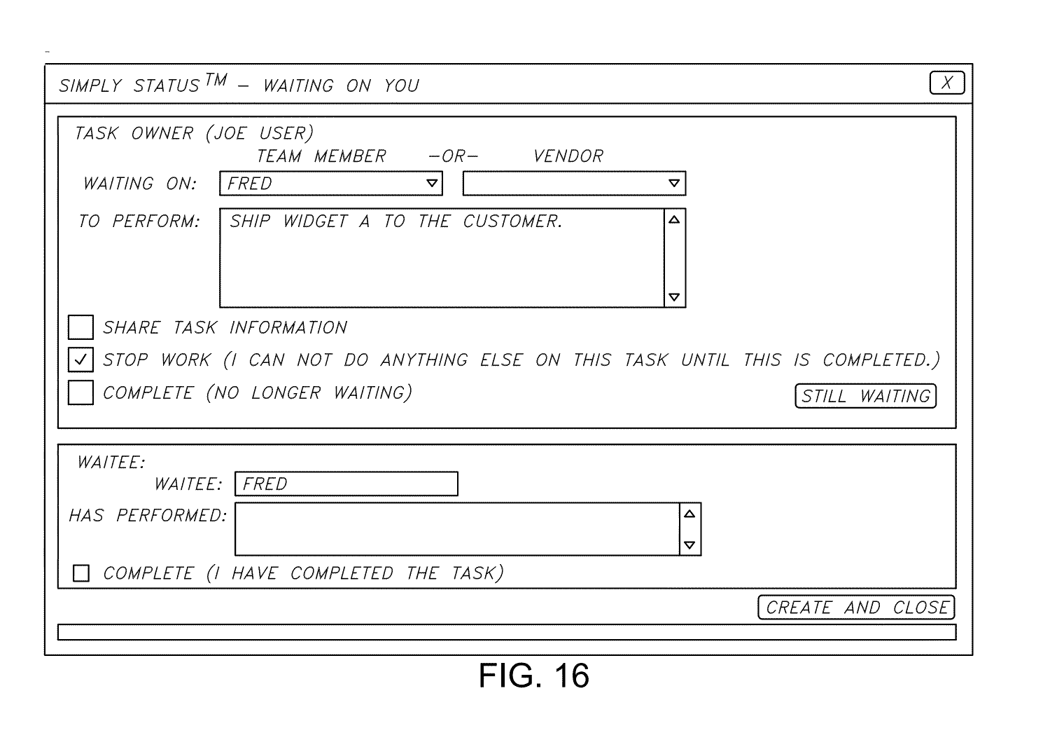

Periodically during project execution, a team member may need to indicate that he is unable to continue working on a task because he or she is dependent on another team member or third party to complete an action. In the current system, the team member can indicate that the task is in a dependency hold status. The team member then indicates the task, resource, team member, or third party which is the source of the dependency hold. FIG. 16 illustrates an interface for inputting a dependency hold (shown as “Waiting on You”). The client 12 14 enables the member or manager to input a team member (or external vendor) as the source of the dependency hold and a description of the reason for the dependency. The team member or manager can also indicate whether the dependency is a complete work stoppage, that is whether the team member can currently perform any further work on the subject task. The client 12 14 records the input and the date and time in which the status is input. Where the source of the dependency is a team member who has access to the project, an in-system notification is sent to that team member. Where the source of the dependency is external to the system, an optional system generated notifier such as email can be used.

While the task is in the dependency hold status, the team member can periodically reaffirm the dependency. The interface records and displays the date and time of the reaffirmation in order to indicate to other system users that the dependency hold is still valid. This is shown as a “Still Waiting” button.

The dependency hold can be removed by a project manager or team member updating the task and clearing the status. Also, where the source of the dependency is another team member, that other team member can indicate that he or she has completed the requested action and update the task in his own member client 12.

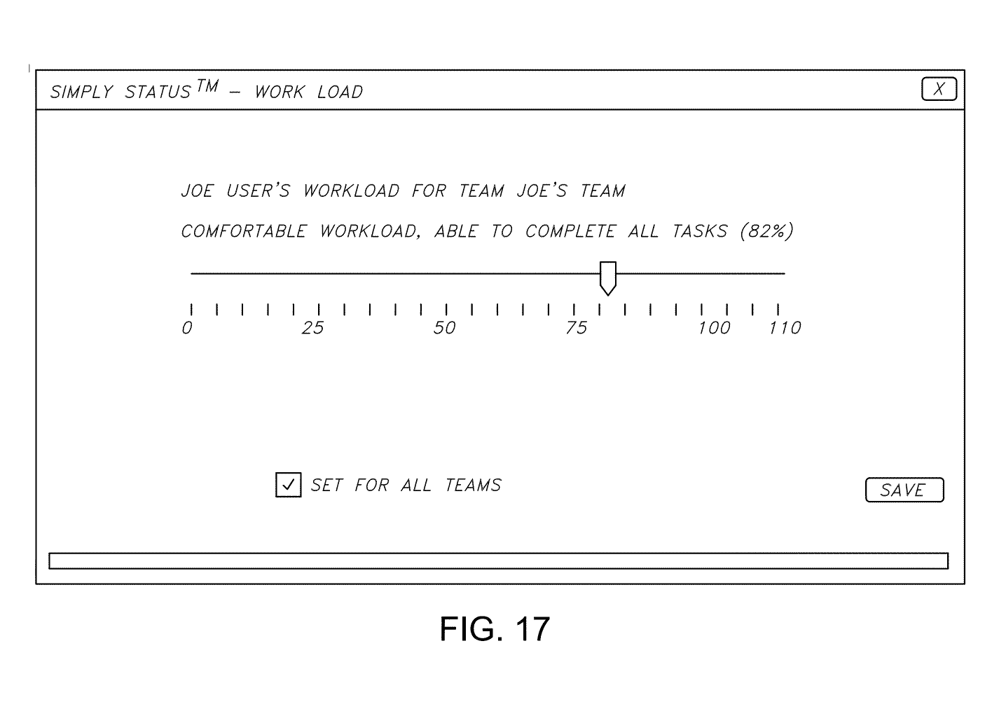

In addition to indicating a decreased workload due to dependencies, a team member can also directly input workload. As shown in FIG. 17, a team member can input his workload as a percentage, demonstrating availability or unavailability to a project manager.

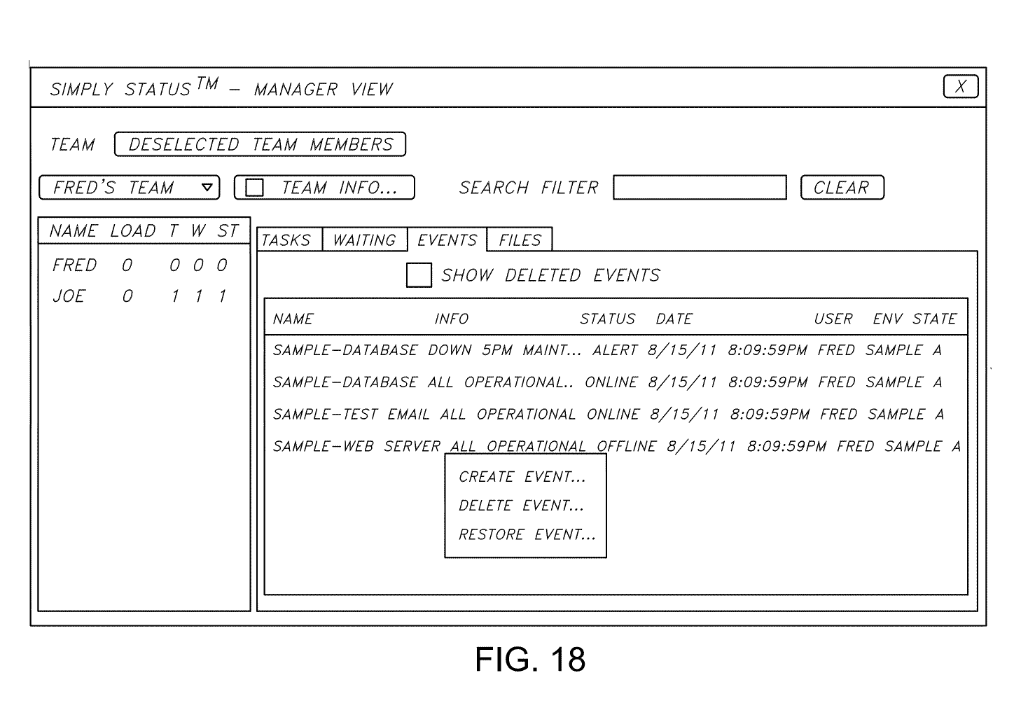

In addition to the team member activity during the project execution phase 120, the project alert monitoring is ongoing. FIG. 18 shows a project alert interface. Where the input to a project alert is manual, a team member inputs data for display in this interface. Where the project alert input is received from a helper application, the application server 18 and the helper application are in communication during project execution. The application server 18 receives and records the input for display in this interface and alerts team members upon the configured conditions.

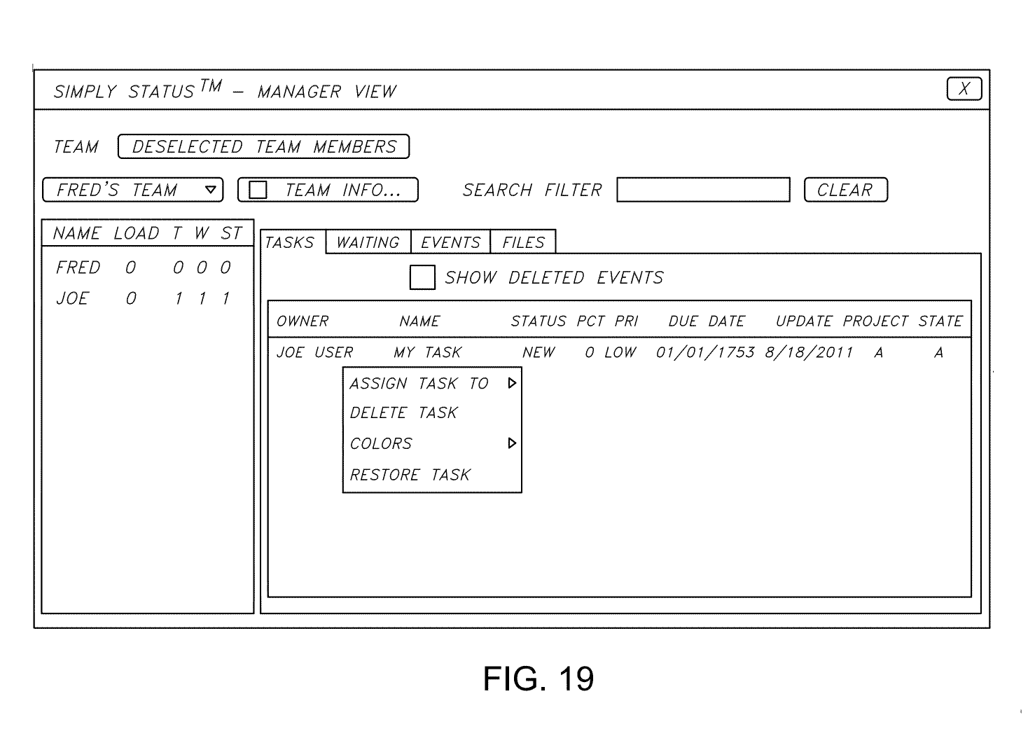

Having disclosed the major team member activities in the system and the project alerts during project execution 120, the disclosure now focuses on the project manager activity and interface during this phase. FIG. 19 depicts the primary manager interface, where the project manager can access the major elements of the system. From this interface, the manager can add or remove team members, view team member information, configure permissions, view the tasks, view tasks by assignment status, assign tasks, update tasks, view the workload percentage of team members, view project alerts, view task histories, view tasks in dependency hold status.

Referring to FIG. 2, the use of the system is shown. The project is started 100. The manager client 14 is used to input users. At step 110, the project environment is configured, with the primary action being configuring the permission structure, selecting team members, and assigning the team members to groups. Next, the tasks for the project are created 115. the project moves in execution phase 120, where the team members generally updates tasks and the project manager monitors the project.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A method inputting, tracking, monitoring, updating task objects within a project comprising:
receiving, over a network, a plurality of task objects associated with said project;
associating a plurality of groups objects with said project;
associated a plurality of team member objects with said project;
associating project functions with said plurality of groups, said project functions defining team member activities within said project and having a project function value;
monitoring team member activity within said project; and
conditionally permitting team member activity based on an effective permission, said effective permission determined from configurable logic based on said team member's group membership and the corresponding group's project functions.

2. The method of claim 1, wherein the project functions are selected from the following: edit permissions, view own tasks, edit own tasks, view other team member tasks, edit other team member tasks, create events, and edit events.

3. The method of claim 1, wherein said project function values are selected from: true, false, undefined.

4. The method of claim 1, wherein said effective permission is configured permissively.

5. The method of claim 1, wherein said effective permission is configured restrictively.

6. The method of claim 1, wherein the clients are configured to exclusively store said project data in volatile memory.

7. The method of claim 1, wherein said project data is stored in a format including a data element, a hash element, and a data format element.

8. The method of claim 7, wherein said data element is encrypted.

9. The method of claim 8, wherein said data element is encrypted and decrypted at the client level.

10. A system for inputting, tracking, monitoring, updating task objects within a project comprising:
a database and one or more processors configured to:
receive, over a network, a plurality of task objects associated with said project;
associate a plurality of groups objects with said project;
associate a plurality of team member objects with said project;
associate project functions with said plurality of groups, said project functions defining team member activities within said project and having a project function value;
monitor team member activity within said project; and
conditionally permitting team member activity based on an effective permission, said effective permission determined from configurable logic based on said team member's group membership and the corresponding group's project functions.

11. The system of claim 10, wherein the project functions are selected from the following: edit permissions, view own tasks, edit own tasks, view other team member tasks, edit other team member tasks, create events, and edit events.

12. The system of claim 10, wherein said project function values are selected from: true, false, undefined.

13. The system of claim 10, wherein said effective permission is configured permissively.

14. The system of claim 10, wherein said effective permission is configured restrictively.

15. The system of claim 10, wherein the clients are configured to exclusively store said project data in volatile memory.

16. The system of claim 10, wherein said project data is stored in a format having a data element, a hash element, and a data format element.

17. The system of claim 10, wherein said data element is encrypted.

18. The system of claim 10, wherein said data element is encrypted and decrypted at the client level.

19. A system for inputting, tracking, monitoring, updating task objects within a project comprising:
a database and one or more processors configured to:
receive, over a network, a plurality of task objects associated with said project;
associate a plurality of groups objects with said project;
associate a plurality of team member objects with said project;
associate project functions with said plurality of groups, said project functions defining team member activities within said project and having a project function value, said project function values are selected from: true, false, and undefined;
monitor team member activity within said project; and
conditionally permitting team member activity based on an effective permission, said effective permission determined from configurable logic based on said team member's group membership and the corresponding group's project functions.
